(19) United States
(12) Patent Application Publication
(10) Pub. No.: US 2012/0099498 A1
(43) Pub. Date: Apr. 26, 2012

(54) SUBSCRIBER STATION AND POWER SAVING METHOD

(75) Inventor: HAN-TZUNG LIN, Tu-Cheng (TW)

(73) Assignee: HON HAI PRECISION INDUSTRY CO., LTD., Tu-Cheng (TW)

(21) Appl. No.: 12/957,227

(22) Filed: Nov. 30, 2010

(30) Foreign Application Priority Data
Oct. 20, 2010 (CN) 201010512920.3

(51) Int. Cl. G08C 17/00; H04L 12/66

(52) U.S. Cl. 370/311; 370/352

(57) ABSTRACT

A subscriber station is connected between a calling client and a base station. The subscriber station provides voice over Internet protocol (VoIP) service for the calling client and a called client via a plurality of service flows that are in a normal working mode. The subscriber station receives at least one silence event from the calling client, and requests the base station to make at least one service flow corresponding to the at least one silence event enter a sleep mode. The subscriber station further receives at least one voice event from the calling client, and requests the base station to make the at least one service flow corresponding to the at least one voice event enter the normal working mode.

### BACKGROUND

1. Technical Field

The present disclosure relates to wireless communications, and more particularly to a subscriber station and a power saving method of the subscriber station.

2. Description of Related Art

Worldwide interoperability for microwave access (WIMAX) is a wireless digital communications standard, also known as IEEE 802.16, which is intended for wireless metropolitan area networks. WIMAX can provide broadband wireless access (BWA) up to 30 miles (about 50 kilometers) for fixed stations, and 3-10 miles (about 5-15 kilometers) for mobile stations.

Voice over Internet protocol (VoIP) refers to a way to carry phone calls over an IP data network, whether on the Internet or an Intranet. A VoIP phone is a typical subscriber on the WIMAX network. A primary attraction of VoIP is its lower expenses of phone calls over the IP data network than that over a public switched telephone network.

VoIP over WIMAX is attractive for both enterprises and carriers, but it is a big challenge how to save power during VoIP over WIMAX.

### BRIEF DESCRIPTION OF THE DRAWINGS

The details of the disclosure, both as to its structure and operation, can best be understood by referring to the accompanying drawing, in which like reference numbers and designations refer to like elements.

FIG. 1 is a schematic diagram of an application environment of one embodiment of a subscriber station in accordance with the present disclosure;

FIG. 2 is a schematic diagram of functional modules of one embodiment of the subscriber station in accordance with the present disclosure;

FIG. 3 is a flowchart of one embodiment of a power saving method in accordance with the present disclosure;

FIG. 4 is a flowchart of another embodiment of the power saving method in accordance with the present disclosure;

FIG. 5 is a detailed transport diagram of blocks S200-S202 of the power saving method of FIG. 4;

FIG. 6 is a detailed transport diagram of blocks S204-S208 of the power saving method of FIG. 4;

FIG. 7 is a detailed transport diagram of blocks S210-S216 of the power saving method of FIG. 4;

FIG. 8 is a detailed transport diagram of blocks S218-220 of the power saving method of FIG. 4; and

FIG. 9 is a schematic diagram of one embodiment of a sleep request message utilized by the power saving method in accordance with the present disclosure.

### DETAILED DESCRIPTION

In order to clearly describe the embodiment of the present disclosure, a worldwide interoperability for microwave access (WIMAX) standard (IEEE 802.16 protocol) related to the present disclosure is introduced. The WIMAX standard defines five quality of service (QoS) service types including unsolicited grant service (UGS), real-time polling service (rtPS), extended real-time polling service (ertPS), non-real-time polling service (nrtPS), and best effort (BE) service. The ertPS is a scheduling mechanism that builds on an efficiency of both UGS and rtPS. The ertPS is designed for real-time traffic with variable data rate, such as VoIP service with silence suppression, over a WIMAX network.

In a WIMAX network, WIMAX connections are utilized to transport signaling (management messages) and data between a subscriber station and a base station. The WIMAX connections for transporting signaling between the subscriber station and the base station are called signaling connections. The WIMAX connections for transporting data between the subscriber station and the base station are called data connections. Each WIMAX connection is identified by a connection identifier (CID).

In order to assure certain QoS, the WIMAX standard defines service flows. Each service flow is a unidirectional flow of packets that are provided a particular QoS. The service flows exist in both uplink (UL) and downlink (DL) directions. Each service flow is identified by a service flow identifier (SFID). Each service flow can be in one of three modes: provisioned, admitted, and active. Each service flow in either admitted or active mode is mapped to a WIMAX connection. The establishment of one service flow uses a two phase model: a service flow is first admitted with provisioned resources, and then the service flow is activated to have the resources committed on an on-demand basis. The active service flow can be de-activated later to conserve network resources.

According to the WIMAX standard, the service flows are managed by dynamic service addition (DSA) messages, dynamic service change (DSC) messages, and dynamic deletion (DSD) messages. The DSA messages are used to create a new service flow, the DSC messages are used to change an existing service flow, and the DSD messages are used to delete an existing service flow.

In combination with the above knowledge related to the WIMAX standard, terms utilized in the embodiments of the present disclosure are introduced. In embodiments of the present disclosure, the service flows are divided to signaling service flows for transporting signaling and data service flows for transporting data. The service flows are further divided to admitted service flows in an admitted mode and active service flows in an active mode. The service flow are further divided to uplink (UL) service flows providing transmissions from a subscriber station to a base station and downlink (DL) service flows providing transmissions from the base station to the subscriber station.

Thus, the service flows utilized by the present disclosure include an active signaling service flow, an admitted data service flow, and an active data service flow. The active signaling service flow includes active uplink and downlink signaling service flows. The admitted data service flow includes admitted uplink and downlink data service flows. The active data service flow includes active uplink and downlink data service flows. For example, the active uplink signaling service flow is a service flow that is in an active mode and transports signaling from a subscriber station to a base station. The admitted uplink data service flow is a service flow that is in an admitted mode and transports data from the subscriber station to the base station. The active downlink data service flow is a service flow that is in an active mode and transports data from the base station to the subscriber station.

Additionally, the service flows in the embodiments of the present disclosure can work in a sleep mode and a normal working mode. One service flow working in the sleep mode consumes less power than that working in the normal working mode.

Furthermore, all of the processes described may be embodied in, and fully automated via, software code modules executed by one or more general purpose computers or processors. The code modules may be stored in any type of computer-readable medium or other storage device. Some or all of the methods may alternatively be embodied in specialized computer hardware or communication apparatus.

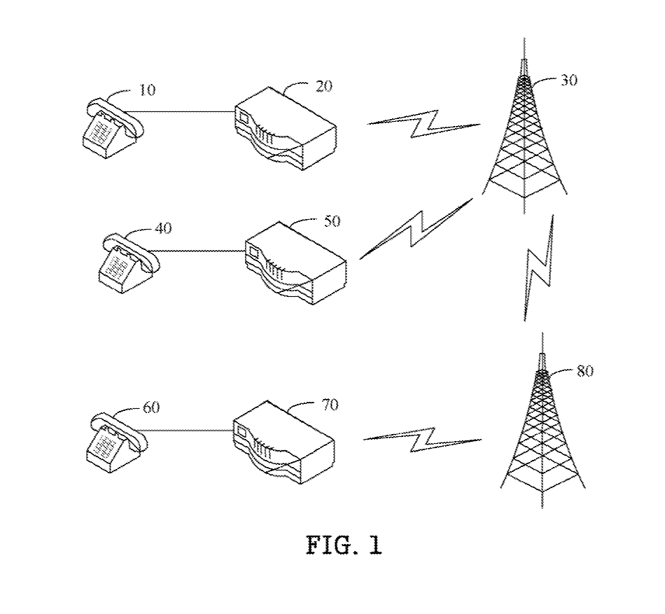

FIG. 1 is a schematic diagram of an application environment of one embodiment of a subscriber station 20 in accordance with the present disclosure. In one embodiment, the subscriber station 20 is applied in a WIMAX network including a plurality of clients 10, 40, 60 (only three shown), a plurality of subscriber station 20, 50, 70 (only three shown), and a plurality of base station 30, 80 (only two shown). The subscriber stations 20, 50, 70 are WIMAX subscriber stations, also called WIMAX customer premises equipments (CPEs). The base stations 30, 80 are WIMAX base stations, also called WIMAX access points (APs). The clients 10, 40, 60 may be telephones.

In one embodiment, one base station (such as 30 or 80) can communicate with and provide service for more than one subscriber station. One subscriber station (such as 20, 50, or 70) can communicate with and provide service for more than one client.

In one embodiment, the subscriber station 20 is connected between the client 10 and the base station 30, and provides voice over Internet protocol (VoIP) service for the client 10, so the client 10 can call other clients via the subscriber station 20. For example, the client 10 may call the client 40 by way of the subscriber station 20, the base station 30, and the subscriber station 50. In another example, the client 10 may call the client 60 via the subscriber station 20, the base station 30, the base station 80, and the subscriber station 70.

In one embodiment, the client 10 (called a “calling client 10” hereinafter) calls another client (called a “called client” hereinafter), such as the client 60, via the subscriber station 20, so the subscriber station 20 provides VoIP service for the calling client 10 and the called client 60 via a plurality of service flows. For example, the subscriber station 20 establishes or ends a session between the calling client 10 and the called client 60 via active uplink and downlink signaling service flows. The subscriber station 20 transmits voice data between the calling client 10 and the called client 60 via active uplink and downlink data service flows that are in a normal working mode.

During the voice data transmission between the calling client 10 and the called client, the calling client 10 transmits an uplink silence event to the subscriber device 20 if the calling client 10 detects that a user of the calling client 10 is silent. The subscriber station 20 receives the uplink silence event, and accordingly requests the base station 30 to make the active uplink data service flow enter a sleep mode based on the uplink silence event. If the calling 10 detects that a user of the called client 60 is silent, the calling client 10 transmits a downlink silence event to the subscriber station 20. The subscriber station 20 receives the downlink silence event, and accordingly requests the base station 30 to make the active downlink data service flow enter a sleep mode based on the downlink silence event.

If the calling client 10 detects the user of the calling client 10 starts to speak, the calling client 10 transmits an uplink voice event to the subscriber device 20.

Upon receiving the uplink voice event, the subscriber station 20 requests the base station 30 to make the active uplink data service flow enter the normal working mode based on the uplink voice event. If the calling client 10 detects that the user of the called client, such as the user of the client 60, starts to speak, the calling client 10 transmits a downlink voice event to the subscriber station 20. The subscriber station 20 receives the downlink voice event, and accordingly requests the base station 30 to make the active downlink data service flow enter the normal working mode based on the downlink voice event.

Thus, power is reduced because the active uplink or downlink data service flow is in the sleep mode while the user of the calling client 10 or the called client is silent.

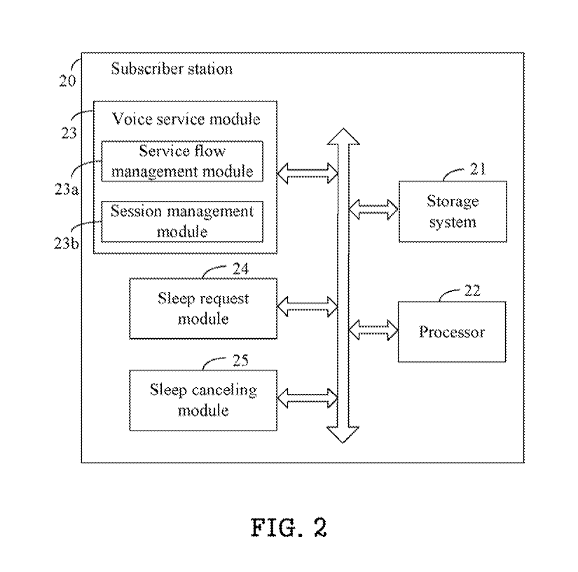

FIG. 2 is a schematic diagram of functional modules of one embodiment of the subscriber station 20 in accordance with the present disclosure. In one embodiment, the subscriber station 20 includes a storage system 21, at least one processor 22, a voice service module 23, a sleep request module 24, and a sleep canceling module 25. The modules 23-25 may comprise computerized code in the form of one or more programs that are stored in the storage system 21. The computerized code includes instructions that are executed by the at least one processor 22 to provide functions for the modules 23-25.

The voice service module 23 is operable to provide VoIP service for the calling client 10 and the called client via a plurality of service flows that are in normal working mode. In one embodiment, the plurality of service flows include an active signaling service flow, an admitted data service flow, and an active data service flow. The active signaling service flow includes active uplink and downlink signaling service flows. The admitted data service flow includes admitted uplink and downlink data service flows. The active data service flow includes active uplink and downlink data service flows.

The voice service module 23 includes a service flow management module 23a and a session management module 23b. In one embodiment, the service flow management module 23a establishes the active signaling service flow and the admitted data service flow with the base station 30. When the calling client 10 calls the called client, the session management module 23b establishes a session between the calling client 10 and the called client via the active signaling service flow. Then the service flow management module 23a changes the admitted data service flow to the active data service flow. During the session, the session management module 23b transmits voice data between the calling client 10 and the called client via the active data service flow. The session management module 23b ends a session between the calling client 10 and the called client when the session is completed.

The sleep request module 24 is operable to receive at least one silence event from the calling client 10, and request the base station 30 to make at least one service flow corresponding to the at least one silence event enter a sleep mode. In one embodiment, the at least one silence event indicates that at least one of users of the calling client 10 and the called client is silent. The at least one silence event includes an uplink silence event corresponding to the active uplink data service flow and a downlink silence event corresponding to the active downlink data service flow. The uplink silence event indicates that the user of the calling client 10 is silent, and the downlink silence event indicates that the user of the called client is silent.

The sleep request module 24 requests the base station 30 to make the active uplink data service flow enter the sleep mode when the sleep request module 24 receives the uplink silence event from the calling client 10. The sleep request module 24 requests the base station 30 to make the active downlink data service flow enter the sleep mode when the sleep request module 24 receives the downlink silence event from the calling client 10.

The sleep canceling module 25 is operable to receive at least one voice event from the calling client 10, and request the base station 30 to make the at least one service flow corresponding to the at least one voice event enter the normal working mode. In one embodiment, the at least one voice event indicates that at least one of the users of the calling client 10 and the called client 60 starts to speak. The at least one voice event includes an uplink voice event corresponding to the active uplink data service flow and a downlink voice event corresponding to the active downlink data service flow. The uplink voice event indicates that the user of the calling client 10 starts to speak, and the downlink voice event indicates that the user of the called client starts to speak.

The sleep canceling module 25 requests the base station 30 to make the active uplink data service flow enter the normal working mode when the sleep canceling module 25 receives the uplink voice event from the calling client 10. The sleep canceling module 25 requests the base station 30 to make the active downlink data service flow enter the normal working mode when the sleep canceling module 25 receives the downlink voice event from the calling client 10.

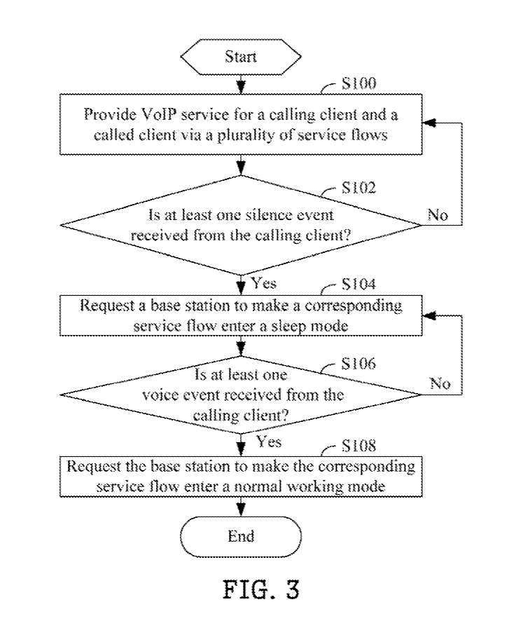

FIG. 3 is a flowchart of one embodiment of a power saving method in accordance with the present disclosure. The method may be embodied in the subscriber station 20, and is executed by the functional modules such as those of FIG. 2. Depending on the embodiment, additional blocks may be added, others deleted, and the ordering of the blocks may be changed while remaining well within the scope of the disclosure.

In block S100, the voice service module 23 provides VoIP service for the calling client 10 and the called client (such as the client 60) via a plurality of service flows that are in a normal working mode. In one embodiment, the plurality of service flows include an active signaling service flow, an admitted data service flow, and an active data service flow. For example, the voice service module 23 establishes a session between the calling client 10 and the called client via the active signaling service flow, and transmits voice data between the calling client 10 and the called client via the active data service flow.

In one embodiment, the active data service flow includes active uplink and downlink and data service flows. The voice service module 23 transmits the voice data from the calling client 10 to the called client via the active uplink data service flow, and transmits the voice data from the called client to the calling client 10 via the active downlink data service flow.

In block S102, the sleep request module 24 determines whether at least one silence event is received from the calling client 10.

If no silence event is received from the calling client 10, the voice service module 23 continues to provide the VoIP service for the calling client 10 and the called client.

If at least one silence event is received from the calling client 10, in block

S104, the sleep request module 24 requests the base station 30 to make at least one service flow corresponding to the at least one silence event enter a sleep mode. In one embodiment, the at least one silence event includes an uplink silence event corresponding to the active uplink data service flow and a downlink silence event corresponding to the active downlink data service flow.

In block S106, the sleep canceling module 25 determines whether at least one voice event is received from the calling client 10.

If no voice event is received from the calling client 10, the at least one service flow corresponding to the at least one silence event is still in the sleep mode.

If at least one voice event is received from the calling client 10, in block S108, the sleep canceling module 25 requests the base station 30 to make at least one service flow corresponding to the at least one voice event enter the normal working mode. In one embodiment, the at least one voice event includes an uplink voice event corresponding to the active uplink data service flow and a downlink voice event corresponding to the active downlink data service flow.

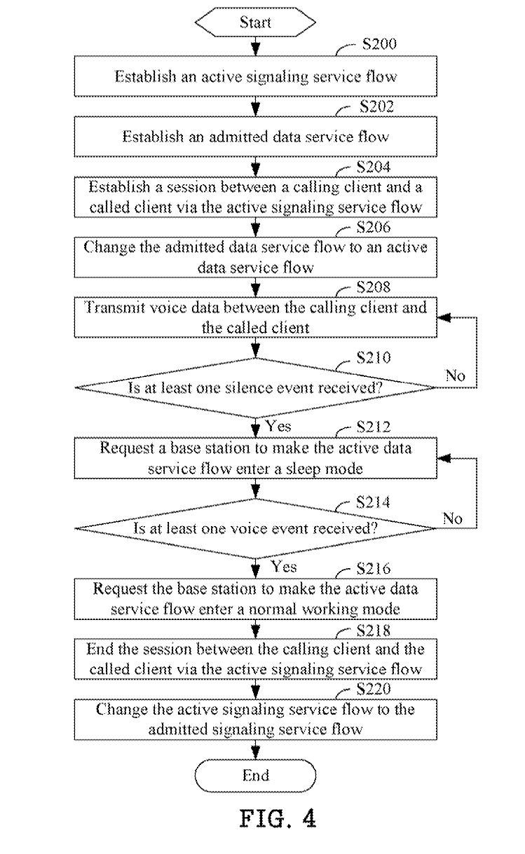

FIG. 4 is a flowchart of another embodiment of the power saving method in accordance with the present disclosure. The method may be embodied in the subscriber station 20, and is executed by the functional modules such as those of FIG. 2. Depending on the embodiment, additional blocks may be added, others deleted, and the ordering of the blocks may be changed while remaining well within the scope of the disclosure.

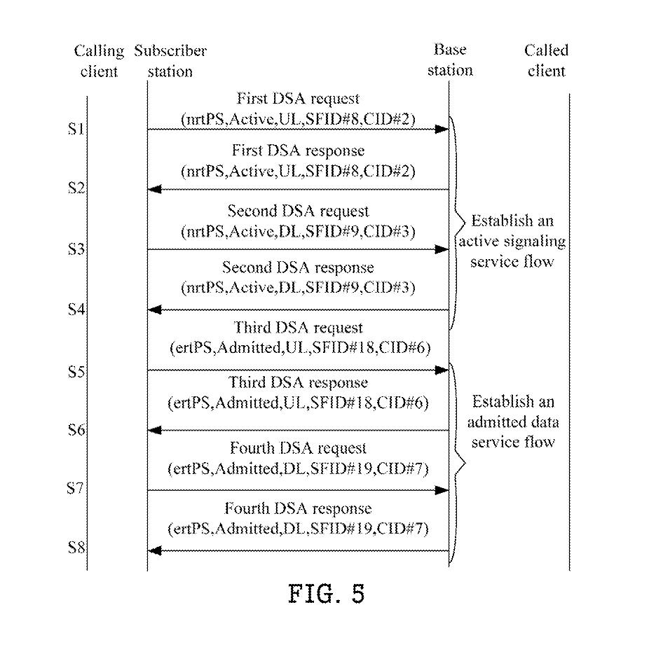

In block S200, the subscriber station 20 establishes an active signaling service flow with the base station 30. In one embodiment, the active signaling service flow includes active uplink and downlink signaling service flows. Details of block S200 are described in blocks S1-S4 of FIG. 5 hereinafter.

In block S202, the subscriber station 20 establishes an admitted data service flow with the base station 30. In one embodiment, the admitted data service flow includes admitted uplink and downlink data service flows. Details of block S202 are described in blocks S5-S8 of FIG. 5 hereinafter.

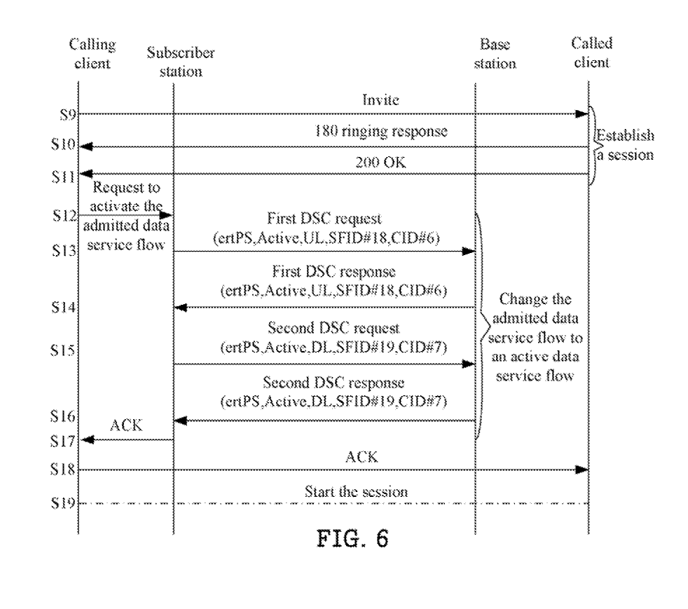

In block S204, the subscriber station 20 establishes a session between the calling client 10 and the called client via the active signaling service flow. Details of block S204 are described in blocks S9-S11 of FIG. 6 hereinafter.

In block S206, the subscriber station 20 changes the admitted data service flow to an active data service flow. In one embodiment, the active data service flow includes active uplink and downlink data service flows. Details of block S206 are described in blocks S12-S18 of FIG. 6 hereinafter.

In block S208, the subscriber station 20 transmits voice data between the calling client 10 and the called client via the active data service flow. Block S208 corresponds to block S19 of FIG. 6 that is described hereinafter.

In block S210, the subscriber station 20 determines whether at least one silence event is received from the calling client 10.

If no silence event is received from the calling client 10, the subscriber station 20 continues to transmit the voice data between the calling client 10 and the called client.

If at least one silence event is received from the calling client 10, in block S212, the subscriber station 20 requests the base station 30 to make at least one service flow corresponding to the at least one silence event enter a sleep mode. In one embodiment, the at least one silence event includes an uplink silence event corresponding to the active uplink data service flow and a downlink silence event corresponding to the active downlink data service flow.

In block S214, the subscriber station 20 determines whether at least one voice event is received from the calling client 10.

If no voice event is received from the calling client 10, the at least one service flow corresponding to the at least one silence event is still in the sleep mode.

If at least one voice event is received from the calling client 10, in block S216, the subscriber station 20 requests the base station 30 to make at least one service flow corresponding to the at least one voice event enter the normal working mode. In one embodiment, the at least one voice event includes an uplink voice event corresponding to the active uplink data service flow and a downlink voice event corresponding to the active downlink data service flow.

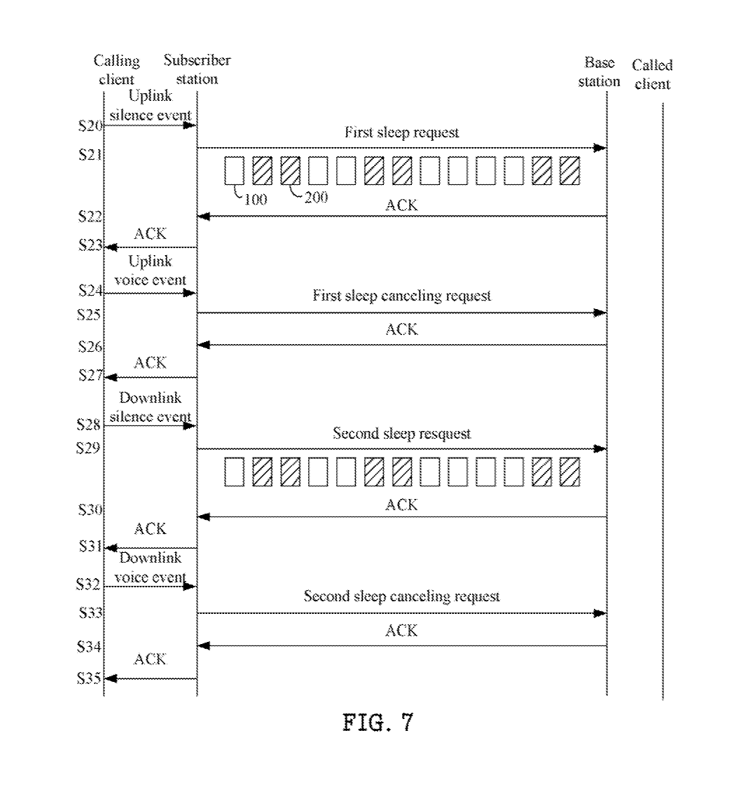

In one embodiment, details of blocks S210-216 of FIG. 4 are described in blocks S20-35 of FIG. 7 hereinafter.

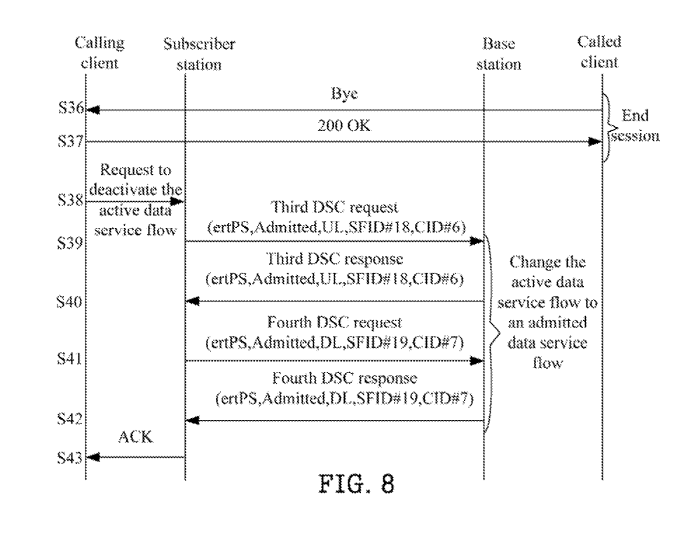

In block S218, the subscriber station 20 ends the session between the calling client 10 and the called client via the active signaling service flow. In one embodiment, details of block S218 are described in block S36-37 of FIG. 8 hereinafter.

In block S220, the subscriber station 20 changes the active data service flow to the admitted data service flow. In one embodiment, details of block S220 are described in block S38-43 of FIG. 8 hereinafter.

FIGS. 5-8 are detailed transport diagrams of the power saving method of FIG. 4.

Please referring to FIG. 5, in block 51, the subscriber station 20 transmits a first DSA request to the base station 30.

In block S2, the subscriber station 20 receives a DSA response from the base station 30.

The first DSA request and the first DSA response are used to establish an active uplink signaling service flow between the subscriber station 20 and the base station 30. In one embodiment, parameters of the first DSA request and the first DSA response are set as follows: a service type of a service flow requested to add is nrtPS, a mode of the service flow requested to add is active, a transport direction of the service flow requested to add is uplink (UL), a SFID of the service flow requested to add is 8, and a CID of a connection mapped to the service flow requested to add is 2.

In block S3, the subscriber station 20 transmits a second DSA request to the base station 30.

In block S4, the subscriber station 20 receives a second DSA response from the base station 30.

The second DSA request and the second DSA response are used to establish an active downlink signaling service flow between the subscriber station 20 and the base station 30. In one embodiment, parameters of the second DSA request and the second DSA response are set as follows: a service type of a service flow requested to add is nrtPS, a mode of the service flow requested to add is active, a transport direction of the service flow requested to add is downlink, a SFID of the service flow requested to add is 9, and a CID of a connection mapped to the service flow requested to add is 3.

In block S5, the subscriber station 20 transmits a third DSA request to the base station 30.

In block S6, the subscriber station 20 receives a third DSA response from the base station 30.

The third DSA request and the third DSA response are used to establish an admitted uplink data service flow between the subscriber station 20 and the base station 30. In one embodiment, parameters of the third DSA request and the third DSA response are set as follows: a service type of a service flow requested to add is ertPS, a mode of the service flow requested to add is admitted, a transport direction of the service flow requested to add is uplink (UL), a SFID of the service flow requested to add is 18, and a CID of a connection mapped to the service flow requested to add is 6.

In block S7, the subscriber station 20 transmits a fourth DSA request to the base station 30.

In block S8, the subscriber station 20 receives a fourth DSA response from the base station 30.

The fourth DSA request and the fourth DSA response are used to establish an admitted downlink data service flow between the subscriber station 20 and the base station 30. In one embodiment, parameters of the fourth DSA request and the fourth DSA response are set as follows: a service type of a service flow requested to add is ertPS, a mode of the service flow requested to add is admitted, a transport direction of the service flow requested to add is downlink, a SFID of the service flow requested to add is 19, and a CID of a connection mapped to the service flow requested to add is 7.

Please referring to FIG. 6, in block S9, the calling client 10 transmits an invite to the called client via the active signaling service flow between the subscriber station 20 and the base station 30.

In block S10, the calling client 10 receives a 180 ringing response from the called client via the active signaling service flow between the subscriber station 20 and the base station 30.

In block S11, the calling client 10 receives a 200 OK from the called client via the active signaling service flow between the subscriber station 20 and the base station 30.

Blocks S9-S11 are used to establish a session between the calling client 10 and the called client.

In block S12, the calling client 10 requests the subscriber station 20 to activate the admitted data service flow including the admitted uplink and downlink data service flows.

In block S13, the subscriber station 20 transmits a first DSC request to the base station 30.

In block S14, the subscriber station 20 receives a first DSC response from the base station 30.

The first DSC request and the first DSC response are used to change the admitted uplink data service flow to an active uplink data service flow. In one embodiment, parameters of the first DSC request and the first DSC response are set as follows: a service type of a service flow requested to change is ertPS, a mode of the service flow requested to change is active, a transport direction of the service flow requested to change is uplink (UL), a SFID of the service flow requested to change is 18, and a CID of a connection mapped to the service flow requested to change is 6.

In block S15, the subscriber station 20 transmits a second DSC request to the base station 30.

In block S16, the subscriber station 20 receives a second DSC response from the base station 30.

The second DSC request and the second DSC response are used to change the admitted downlink data service flow to an active downlink data service flow. In one embodiment, parameters of the second DSC request and the second DSC response are set as follows: a service type of a service flow requested to change is ertPS, a mode of the service flow requested to change is active, a transport direction of the service flow requested to change is downlink (DL), a SFID of the service flow requested to change is 19, and a CID of a connection mapped to the service flow requested to change is 7.

In block S17, the subscriber station 20 transmits an acknowledgement (ACK) message to the calling client 10 to inform that the admitted uplink and downlink service flows have been changed to the active uplink and downlink service flows.

In block S18, the calling client 10 transmits an acknowledgement (ACK) message to the called client via the subscriber station 20 and the base station 30 to inform that the admitted uplink and downlink data service flows have been changed to the active uplink and downlink service flows.

In block S19, the calling client 10 starts the session with called client via the subscriber station 20 and the base station 30. That is, voice data is transmitted between the calling client 10 and the called client via the active uplink and downlink data service flows between the subscriber station 20 and the base station 30.

Please referring to FIG. 7, in block S20, the calling client 10 detects that a user of the calling client 10 is silent and transmits an uplink silence event to the subscriber station 20. In one embodiment, the uplink silence event corresponds to the active uplink data service flow.

In block S21, the subscriber station 20 transmits a first sleep request to the base station 30 to request to make the active uplink data service flow to enter a sleep mode. In one embodiment, the sleep mode includes sleep windows and listening windows. The sleep windows alternate the listening windows with fixed length of 2, and the sleep windows are doubled. In one example, each sleep or listening window may be 10 microsecond (ms).

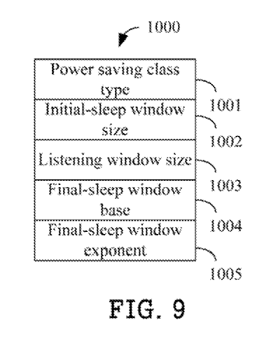

In one embodiment, the first sleep request may be the sleep request message 1000 of FIG. 9 that includes a power saving class type 1001, an initial-sleep window size 1002, a listening window size 1003, a final-sleep window base 1004, and a final-sleep window exponent 1005. In one example, the power saving class type 1001 may be set to a sleep mode with class 1 defined by the WIMAX standard. The initial-sleep window size 1002 may be set to 1, the listening window size 1003 may be set to 2, the final-sleep window base 1004 may be set to 2, and the final-sleep window exponent 1005 may be set to 8.

Referring back to FIG. 7, in block S22, the base station 30 transmits an acknowledgement (ACK) message to the subscriber station 20 to inform that the active uplink data service flow has entered the sleep mode.

In block S23, the subscriber station 20 transmits another acknowledgement (ACK) message to the calling client 10 to inform that the active uplink data service flow has entered the sleep mode.

In block S24, the calling client 10 detects that the user of the calling client 10 starts to speak and transmits an uplink voice event to the subscriber station 20. In one embodiment, the uplink voice event corresponds to the active uplink data service flow.

In block S25, the subscriber station 20 transmits a first sleep canceling request to the base station 30 to request to make the active uplink data service flow to enter the normal working mode.

In block S26, the base station 30 transmits an acknowledgement (ACK) message to the subscriber station 20 to inform that the active uplink data service flow has entered the normal working mode.

In block S27, the subscriber station 20 transmits another acknowledgement (ACK) message to the calling client 10 to inform that the active uplink data service flow has entered the normal working mode.

In block S28, the calling client 10 detects that a user of the called client is silent and transmits a downlink silence event to the subscriber station 20. In one embodiment, the downlink silence event corresponds to the active downlink data service flow.

In block S29, the subscriber station 20 transmits a second sleep request to the base station 30 to request to make the active downlink data service flow to enter a sleep mode. In one embodiment, the sleep mode includes sleep windows and listening window. The sleep windows alternate the listening windows with a fixed length of 2, and the sleep windows are doubled. In one example, each sleep or listening window may be 10 microsecond (ms). In one embodiment, the second sleep request may be the sleep request message 1000 of FIG. 9.

In block S30, the base station 30 transmits an acknowledgement (ACK) message to the subscriber station 20 to inform that the active downlink data service flow has entered the sleep mode.

In block S31, the subscriber station 20 transmits another acknowledgement (ACK) message to the calling client 10 to inform that the active downlink data service flow has entered the sleep mode.

In block S32, the calling client 10 detects that the user of the called client starts to speak and transmits a downlink voice event to the subscriber station 20. In one embodiment, the downlink voice event corresponds to the active downlink data service flow.

In block S33, the subscriber station 20 transmits a second sleep canceling request to the base station 30 to request to make the active downlink data service flow to enter the normal working mode.

In block S34, the base station 30 transmits an acknowledgement (ACK) message to the subscriber station 20 to inform that the active downlink data service flow has entered the normal working mode.

In block S35, the subscriber station 20 transmits another acknowledgement (ACK) message to the calling client 10 to inform that the active downlink data service flow has entered the normal working mode.

Please referring to FIG. 8, in block S36, the calling client 10 receives a bye message from the called client via the active signaling service flow between the subscriber station 20 and the base station 30.

In block S37, the calling client 10 transmits a 200 OK to the called client via the active signaling service flow between the subscriber station 20 and the base station 30.

Blocks S36-S37 are used to end the session between the calling client 10 and the called client.

In block S38, the calling client 10 requests the subscriber station 20 to deactivate the active data service flow including the active uplink and downlink data service flows.

In block S39, the subscriber station 20 transmits a third DSC request to the base station 30.

In block S40, the subscriber station 20 receives a third DSC response from the base station 30.

The third DSC request and the third DSC response are used to change the active uplink data service flow to an admitted uplink data service flow. In one embodiment, parameters of the third DSC request and the third DSC response are set as follows: a service type of a service flow requested to change is ertPS, a mode of the service flow requested to change is admitted, a transport direction of the service flow requested to change is uplink (UL), a SFID of the service flow requested to change is 18, and a CID of a connection mapped to the service flow requested to change is 6.

In block S41, the subscriber station 20 transmits a fourth DSC request to the base station 30.

In block S42, the subscriber station 20 receives a fourth DSC response from the base station 30.

The fourth DSC request and the fourth DSC response are used to change the active downlink data service flow to an admitted downlink data service flow. In one embodiment, parameters of the fourth DSC request and the fourth DSC response are set as follows: a service type of a service flow requested to change is ertPS, a mode of the service flow requested to change is admitted, a transport direction of the service flow requested to change is downlink (DL), a SFID of the service flow requested to change is 19, and a CID of a connection mapped to the service flow requested to change is 7.

In block S43, the subscriber station 20 transmits an acknowledgement (ACK) message to the calling client 10 to inform that the active uplink and downlink data service flows have been changed to the admitted uplink and downlink data service flows.

Thus, the active uplink or/and downlink service flow are requested to enter the sleep mode when the users of the calling client 10 or/and the called client are silent, thus power is reduced.

While various embodiments and methods of the present disclosure have been described above, it should be understood that they have been presented by way of example only and not by way of limitation. Thus the breadth and scope of the present disclosure should not be limited by the above-described embodiments, but should be defined only in accordance with the following claims and their equivalents.

What is claimed is:

1. A subscriber station connected between a calling client and a base station communicating with a called client, the subscriber station comprising:
at least one processor;
a storage system;
one or more programs that are stored in the storage system and are executed by the at least one processor, the one or more programs comprising:
a voice service module operable to provide voice over Internet protocol (VoIP) service for the calling client and the called client via a plurality of service flows that are in a normal working mode;
a sleep request module operable to receive at least one silence event from the calling client, and request the base station to make at least one service flow corresponding to the at least one silence event enter a sleep mode, wherein the at least one silence event indicates that at least one of users of the calling client and the called client is silent; and
a sleep canceling module operable to receive at least one voice event from the calling client, and request the base station to make the at least one service flow corresponding to the at least one voice event enter the normal working mode, wherein the at least one voice event indicates that at least one of the users of the calling client and the called client starts to speak.

2. The subscriber station of claim 1, wherein the plurality of service flows comprise an active signaling service flow, an admitted data service flow, and an active data service flow.

3. The subscriber station of claim 2, wherein the voice service module comprises:
a service flow management module operable to establish the active signaling service flow and the admitted data service flow with the base station, and change between the admitted data service flow and the active data service flow; and
a session management module operable to establish a session between the calling client and the called client via the active signaling service flow, transmit voice data between the calling client and the called client via the active data service flow, and end the session between the calling client and the called client via the active signaling service flow when the session is completed.

4. The subscriber station of claim 3, wherein the active signaling service flow comprises active uplink and downlink signaling service flows, the admitted data service flow comprises admitted uplink and downlink data service flows, and the active data service flow comprises active uplink and downlink data service flows.

5. The subscriber station of claim 4, wherein the at least one silence event comprises an uplink silence event corresponding to the active uplink data service flow and a downlink silence event corresponding to the active downlink data service flow, the uplink silence event indicates that the user of the calling client is silent, and the downlink silence event indicates that the user of the called client is silent.

6. The subscriber station of claim 5, wherein the sleep request module transmits a first sleep request message to the base station to request to make the active uplink data service flow enter the sleep mode when the sleep request module receives the uplink silence event from the calling client, and transmit a second sleep request message to the base station to request to make the active downlink data service flow enter the sleep mode when the sleep request module receives the downlink silence event from the calling client.

7. The subscriber station of claim 6, wherein each of the first sleep request message and the second sleep request message comprises a power saving class type that is set to a sleep mode with class 1 complied with a worldwide interoperability for microwave access (WIMAX) standard.

8. The subscriber station of claim 4, wherein the at least one voice event comprises an uplink voice event corresponding to the active uplink data service flow and a downlink voice event corresponding to the active downlink data service flow, the uplink voice event indicates that the user of the calling client starts to speak, and the downlink voice event indicates that the user of the called client starts to speak.

9. The subscriber station of claim 8, wherein the sleep canceling module requests the base station to make the active uplink data service flow enter a normal working mode when the sleep canceling module receives the uplink voice event from the calling client, and requests the base station to make the active downlink data service flow enter a normal working mode when the sleep canceling module receives the downlink voice event from the calling client.

10. A power saving method of a subscriber station connected between a calling client and a base station communicating with a called client, the power saving method comprising:
providing voice over Internet protocol (VoIP) service for the calling client and the called client via a plurality of service flows that are in a normal working mode;
receiving at least one silence event from the calling client;
requesting the base station to make at least one service flow corresponding to the at least one silence event enter a sleep mode, wherein the at least one silence event indicates that at least one of users of the calling client and the called client is silent;
receiving at least one voice event from the calling client; and
requesting the base station to make the at least one service flow corresponding to the at least one voice event enter the normal working mode, wherein the at least one voice event indicates that at least one of the users of the calling client and the called client starts to speak.

11. The power saving method of claim 10, wherein the plurality of service flows comprise an active signaling service flow, an admitted data service flow, and an active data service flow.

12. The power saving method of claim 11, wherein the providing block comprises:
establishing the active signaling service flow with the base station;
establishing the admitted data service flow with the base station;
establishing a session between the calling client and the called client via the active signaling service flow;
changing the admitted data service flow to an active data service flow; and
transmitting voice data between the calling client and the called client via the active data service flow.

13. The power saving method of claim 11, wherein the active signaling service flow comprises active uplink and downlink signaling service flows, the admitted data service flow comprises admitted uplink and downlink data service flows, and the active data service flow comprises active uplink and downlink data service flows.

14. The power saving method of claim 13, wherein the at least one silence event comprises an uplink silence event corresponding to the active uplink data service flow and a downlink silence event corresponding to the active downlink data service flow, the uplink silence event indicates that the user of the calling client is silent, and the downlink silence event indicates that the user of the called client is silent.

15. The power saving method of claim 14, wherein the block of requesting the base station to make the at least one service flow enter to a sleep mode comprises:
transmitting a first sleep request message to the base station to request to make the active uplink data service flow enter the sleep mode when receiving the uplink silence event from the calling client; and
transmitting a second sleep request message to the base station to request to make the active downlink data service flow enter the sleep mode when receiving the downlink silence event from the calling client.

16. The power saving method of claim 15, wherein each of the first sleep request message and the second sleep request message comprises a power saving class type that is set to a sleep mode with class 1 complied with a WIMAX standard.

17. The power saving method of claim 13, wherein the at least one voice event comprises an uplink voice event corresponding to the active uplink data service flow and a downlink voice event corresponding to the active downlink data service flow, the uplink voice event indicates that the user of the calling client starts to speak, and the downlink voice event indicates that the user of the called client starts to speak.

18. The power saving method of claim 17, wherein the block of requesting the base station to make the at least one service flow enter the normal working mode comprises:
requesting the base station to make the active uplink data service flow enter the normal working mode when receiving the uplink voice event from the calling client; and
requesting the base station to make the active downlink data service flow enter the normal working mode when receiving the downlink voice event from the calling client.
